(19) United States
(12) Patent Application Publication
(10) Pub. No.: US 2008/0284759 A1
(43) Pub. Date: Nov. 20, 2008

(54) DISPLAY ELEMENT DRIVING DEVICE AND METHOD THEREOF

(75) Inventor: Tae Kwang Park, Seoul (KR)

Correspondence Address: FENWICK & WEST LLP, SILICON VALLEY CENTER, 801 CALIFORNIA STREET, MOUNTAIN VIEW, CA, 94041, US

(73) Assignee: Leadis Technology, Inc., Sunnyvale, CA (US)

(21) Appl. No.: 12/113,445

(22) Filed: May 1, 2008

(30) Foreign Application Priority Data
May 15, 2007 (KR) 10-2007-0046870

(51) Int. Cl. G09G 5/00

(52) U.S. Cl. 345/204

(57) ABSTRACT

Disclosed are a device and a method for driving a display element that adjusts a backlight luminescence to be suitable for a mean luminescence of an image data for each frame, analyzes the mean, maximum and minimum luminescence of an image to be displayed to reduce power consumption due to unnecessary backlight luminescence, and then adjusts the backlight luminescence in accordance with the analyzed result. The device for driving a display element includes a buffer memory, a histogram analyzer, a main memory, a maximum luminescence determining and mapping unit and a digital-to-analog converter (DAC). When an image data to be displayed for each frame is inputted to the buffer memory, the histogram analyzer analyzes the image data for each frame to calculate a mean luminescence, a maximum/minimum luminescence and a histogram for each of the R, G and B colors, and then outputs the analyzed image data for each frame to the maximum luminescence determining and mapping unit. Accordingly, a backlight luminescence is adjusted for each frame in accordance with the maximum luminescence, the minimum luminescence and the histogram for each color, and output value for each gray is compensated by the adjusted backlight luminescence, thereby maintaining a screen luminescence almost similar to the original luminescence and reducing power consumption.

### CROSS-REFERENCE TO RELATED APPLICATION

This patent application claims priority under 35 U.S.C. §119(a) from Republic of Korea Patent Application No. 10-2007-0046870, filed on May 15, 2007, which is incorporated by reference herein in its entirety.

### BACKGROUND OF INVENTION

1. Technical Field

The present invention relates to a device and a method for driving a display element.

2. Discussion of the Related Art

Information provided to a user through an image display device contains not only simple text information but also various contents such as still images, moving images and sound. Particularly, since moving images among the various types of multimedia information are based on video on demand (VOD) services or interactive services, studies on standards related to the moving images have been actively conducted.

With the development of digital electronics technology, the conventional analog data are digitized and thus various digital image processing technologies have appeared to effectively deal with enormous data. Advantages of such digital image processing technologies are as follows.

First, since unnecessary noises are necessarily added when original analog signals are processed by an analog image processing device, degradation of image quality may occur in analog signals processed through such a processing procedure. On the other hand, no degradation of image quality occurs in a digital image processing.

Second, since signals processed after being digitized, computer-aided signal processing is possible. That is, image signals are processed by computers and, thus various image processing operations such as compressing of image information become possible.

Currently, RGB color model is employed in most digital image signal display devices such as liquid crystal displays (LCDs), plasma display panel (PDPs) and organic light emitting diodes (OLEDs).

A color model is a method of expressing a relation between one color and other colors. Different color models are used in different image processing systems for different reasons. The RGB color model consists of three primary colors, i.e., red (R), green (G) and blue (B), which can be added to one another. Spectrum components of these colors are additionally combined to create a color.

The technical field of techniques for improving luminescence and contrast of images in an image expressing device based on RGB image information is largely divided into a field in which the minimum/maximum/mean of luminance is used, a field in which user's settings are applied using reference images, and a field in which the histogram of luminance is analyzed.

The present invention belongs to a field in which a histogram is analyzed to calculate histograms of mean, maximum, minimum and color luminescence of colors for each frame, a backlight luminescence is adjusted to be suitable for the luminescence of a frame, and the luminescence of each gray data is remapped in accordance with the backlight luminescence, thereby maintaining the original luminescence and reducing power consumption.

As illustrated in FIG. 1, in a related art, image data for each frame is stored in a buffer memory 101 and the main memory 304, and the pixel number distribution and maximum and minimum luminescence of the image data are calculated for each luminescence in a histogram analyzer 102. Then, the maximum backlight luminescence is determined based on the calculated value and the original luminescence of each pixel is mapped to an adjusted luminescence within the limit of the determined maximum luminescence by the maximum luminescence determining and mapping unit 303, and the adjusted luminescence is then provided to a display element 306 through a digital-to-analog converter (DAC) 305.

Problems of the related art are as follows.

In the related art, the original luminescence of an image data of a frame (N) stored in a main memory 304 is mapped to an adjusted luminescence by a maximum luminescence value determined based on the maximum, minimum and mean luminescence values calculated with image data of the frame (N) stored in a buffer memory 391 and the number (allowable value) of pixels having a luminescence brighter than the determined maximum luminescence. That is, since image data of an (N+1)-th frame are displayed based on the maximum luminescence obtained by analyzing data of an N-th frame, image quality is not degraded so much when a color difference between the two frames is not great. However, when a color difference between the two frames is great, the luminescence between the frames is not continuous and thus image quality may be degraded. This problem is more serious when still images are changed.

### SUMMARY OF THE INVENTION

Therefore, the present invention is directed to solve the problem of the related art in that the maximum backlight luminescence in a current frame to be displayed is determined by color data of the previous frame, although the display backlight control (DBC) technology is employed, which can reduce power consumption required for maintaining a backlight luminescence by providing the backlight luminescence that is uniform regardless of image data in a frame.

To achieve these objects of the present invention, a basic configuration of the present invention is to search parameters, i.e., a mean luminescence, a maximum/minimum luminescence for each color and a frequency for each luminescence (a histogram for each luminescence) in each frame and then control backlight luminescence to be suitable for the searched parameters. This will be described below.

According to an aspect of the present invention, there is provided a display element driving device, which includes: a buffer memory for receiving a frame image data and temporarily storing the frame image data; a main memory for receiving the frame image data inputted from the buffer memory and storing the inputted frame image data; a histogram analyzer for receiving the frame image data to analyze a color distribution for each frame; a maximum luminescence determining and mapping unit for receiving an output of the histogram analyzer to map a luminescence in accordance with an adjusted maximum luminescence; and a digital-to-analog converter (DAC) for receiving an output of the maximum luminescence determining and mapping unit to convert the output into an electrical signal and then output the electrical signal.

According to another aspect of the present invention, there is provided a display element driving method, which includes: receiving a frame image data and storing the frame image data in a buffer memory; inputting the frame image data stored in the buffer memory to a main memory; inputting the frame image data to a histogram analyzer to analyze a color distribution for each frame and then output the analyzed color distribution; inputting the output from the histogram analyzer to a maximum luminescence determining and mapping unit to map a luminescence in accordance with an adjusted maximum luminescence and then output the mapped luminescence; and inputting the output from the maximum luminescence determining and mapping unit to a DAC to convert the output into an electrical signal and then output the electrical signal to a display element.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a block diagram illustrating a structure of a conventional display backlight control (DBC);

FIG. 2a is a graph illustrating a process of selecting a screen luminescence depending on a maximum backlight luminescence;

FIG. 2b is a graph illustrating a process of mapping original grays in accordance with a change in maximum backlight luminescence;

FIGS. 3a, 3b, 3c, and 3d are block diagrams showing a structure of a display element driving device having a histogram analyzer and a maximum luminescence determining and mapping unit according to embodiments of the present invention;

FIG. 4 is a graph illustrating a distribution of pixels for each luminescence in one frame, analyzed by a histogram analyzer; and

FIGS. 5a and 5b illustrate a digital-to-analog converter (DAC) for converting an image data mapped for a luminescence outputted from a maximum luminescence determining and mapping unit into an electrical signal according to an embodiment of the present invention.

### DETAILED DESCRIPTION OF EMBODIMENTS

The display backlight control (DBC) technology used in the present invention will be described as follows.

When a color is displayed in a display panel on which an image is displayed per frame, a backlight is required. For a dark frame, no image quality problem occurs even at low luminance of backlight, since the screen is dark on the whole. On the other hand, for a bright frame, a desired luminescence is obtained when the luminance of the backlight is increased relatively.

Therefore, in order to reduce power consumption required for obtaining the unnecessary luminescence of a backlight by adjusting the luminescence of the backlight suitable for the mean luminescence of image data for each frame, the mean, maximum and minimum luminescence of an image to be displayed per frame are measured, and the luminescence of the backlight is lowered in accordance with the measured results, thereby reducing power consumption. In such a process, the original luminescence (gray) of the color is mapped within a changed maximum luminescence, thereby reducing power consumption and minimizing degradation of image quality.

The concept of the DBC technology will be described below in further detail.

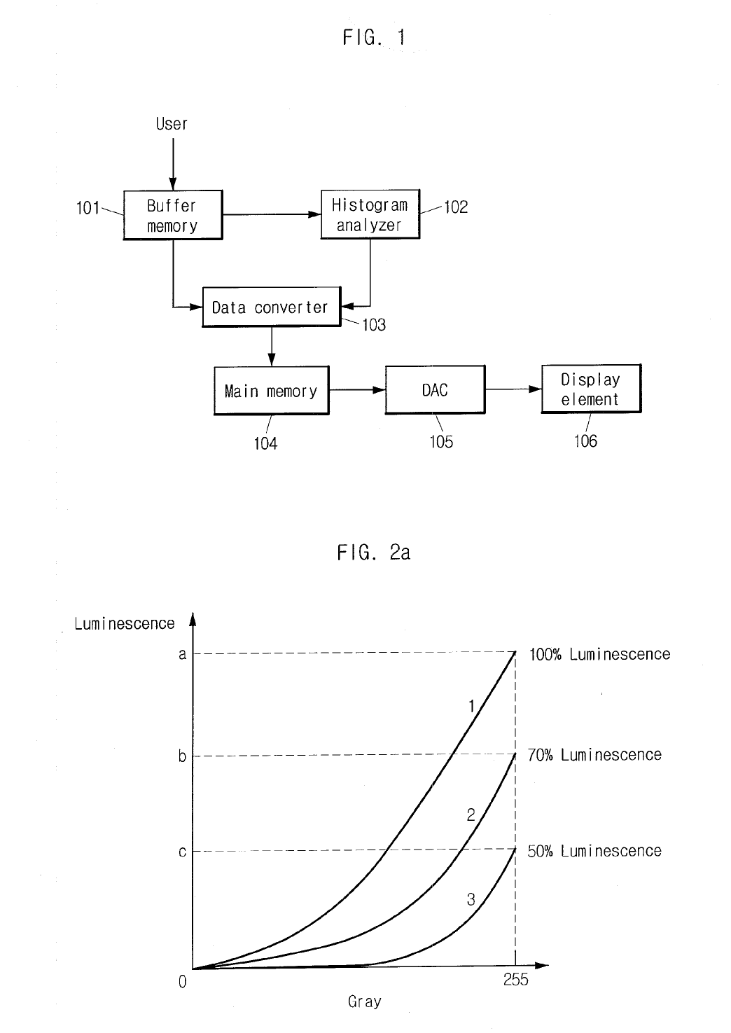

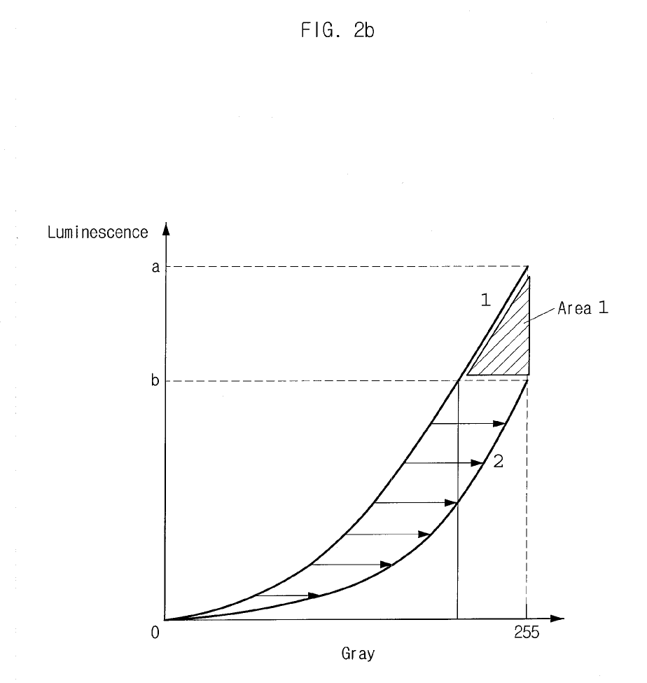

FIG. 2a is a graph illustrating a process of mapping grays in accordance with one selected from several maximum backlight luminescence. As illustrated in the graph, the luminescence of each color (RGB) is divided into 256 steps (0 to 255), and a backlight should be provided to implement the luminescence of the color for each step. Respective curves on the graph will be described as follows.

When the maximum backlight luminescence is “a” (100% of the maximum luminescence), the curve 1 is selected on the graph, and the backlight luminescence at the step 255, that is the maximum luminescence step, should have the luminescence “a”. When the maximum backlight luminescence is “b” (70% of the maximum luminescence), the curve 2 is selected on the graph, and the backlight luminescence at the step 255, that is the maximum luminescence step, should have the luminescence “b”. When, the maximum backlight luminescence is “c” (50% of the maximum luminescence), the curve 3 is selected on the graph, and the backlight luminescence at the step 255, that is the maximum luminescence step, should have the luminescence “c”.

When the maximum luminescence at step 255 is determined, a display luminescence at a step lower than the step is determined by the corresponding curve.

FIG. 2b is a graph illustrating a process of mapping original grays in accordance with a change in maximum backlight luminescence. The process will be described below with reference to FIG. 2b.

When the maximum backlight luminescence is determined to be the luminescence “b”, grays of an original color curve 1 are mapped to a color curve 2. In the color curve 1, a color area (Area 1) of pixels having luminescence brighter than “b” is all mapped to the luminescence “b”, and the mapping algorithm is performed by a maximum luminescence determining and mapping unit. The number of pixels corresponding to the Area 1 is within an allowable value. A histogram analyzer calculates the number of pixels, and the maximum luminescence determining and mapping unit receives the result inputted by the histogram analyzer to perform maximum luminescence determining and mapping.

That is, when the maximum backlight luminescence is selected, the backlight luminescence provided at the maximum luminescence step is changed, and luminescence steps displayed for respective steps are mapped according to a corresponding color curve.

If the maximum luminescence for each frame is determined by the maximum luminescence determining and mapping unit based on the number of pixels for each color luminescence analyzed by the histogram analyzer, it is determined which curve will be used, and backlight luminescence for the respective steps are mapped to be suitable for the selected curve.

Hereinafter, preferred embodiments of the present invention will be described in detail with reference to the accompanying drawings. Advantages and features of the present invention, and methods for achieving them will be apparent with reference to the detailed description of the exemplary embodiments together with the accompanying drawings. However, the present invention is not limited to the embodiments but may be implemented into different forms. These embodiments are provided only for illustrative purposes and for full understanding of the scope of the present invention by those skilled in the art. Like reference numerals indicate like elements throughout the specification and drawings.

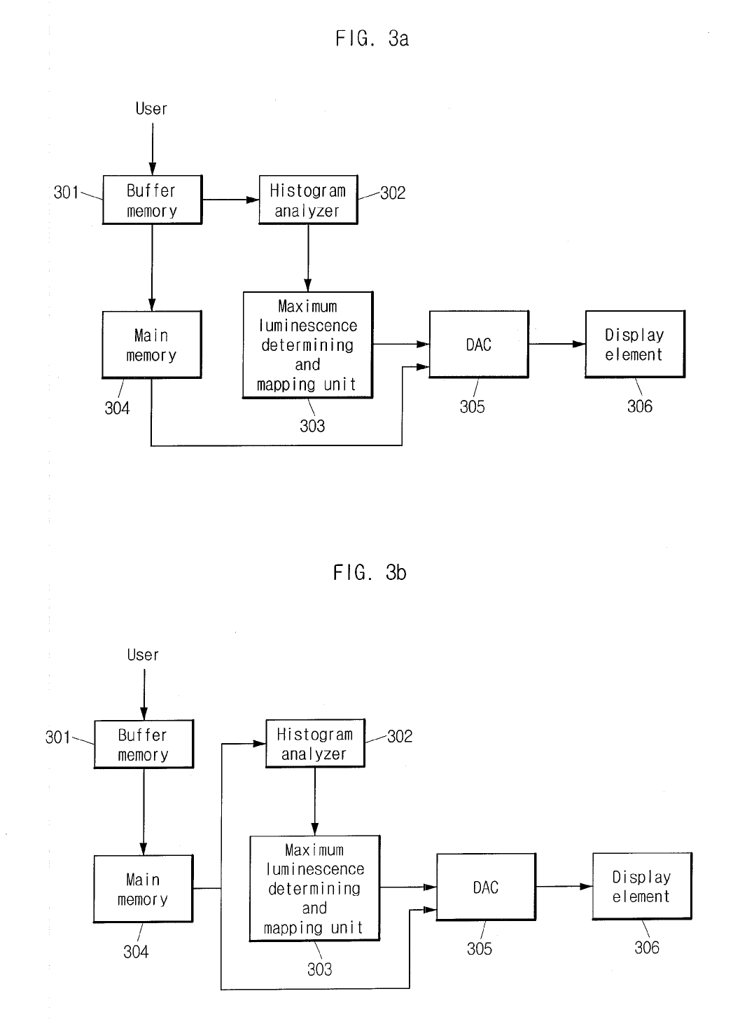

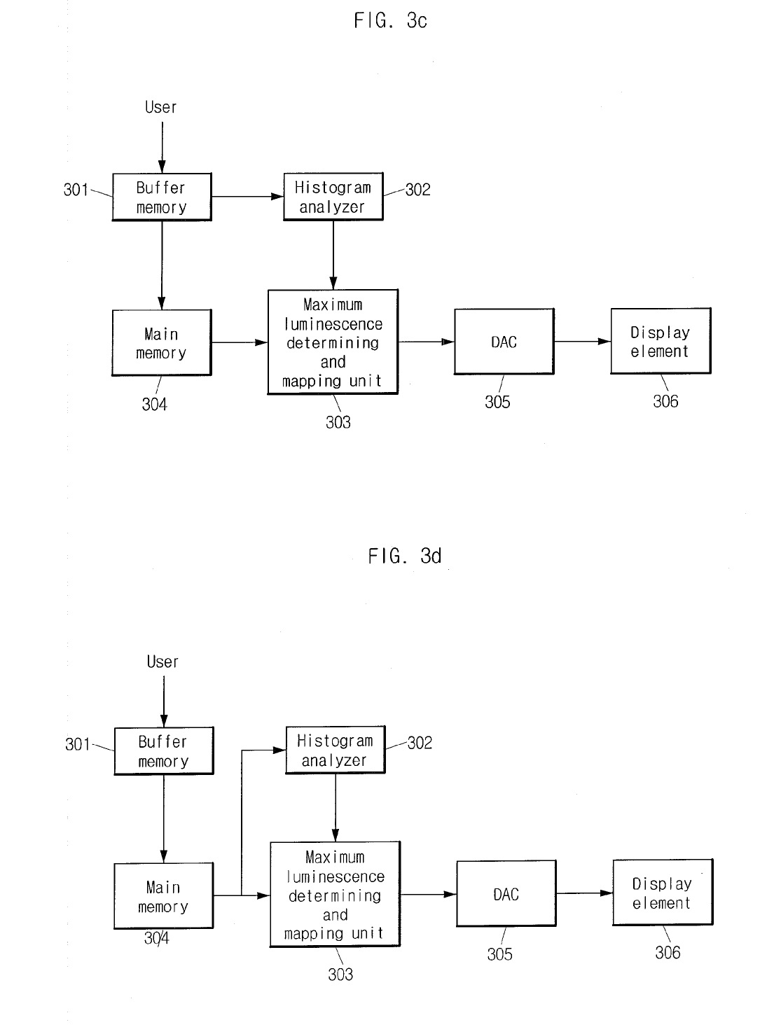

FIGS. 3a, 3b, 3c, and 3d illustrate some embodiments of the present invention.

FIG. 3a is a block diagram showing a structure of a device for driving a display element, having a histogram analyzer and a maximum luminescence determining and mapping unit according to embodiments of the present invention. The display element device driving device includes a buffer memory 301, a histogram analyzer 302, a maximum luminescence determining and mapping unit 303, a main memory 304 and a digital-to-analog converter (DAC) 305.

The buffer memory 301 receives a still image or a moving image inputted from a predetermined image source and then stores data for respective frames that are respective pixels constituting the inputted image, i.e., R, G and B components.

The histogram analyzer 302 receives R, G and B signals for an image from the buffer memory 301 to generate a luminescence distribution histogram for each color in the image signals and then calculates parameters that represent the luminescence distribution histogram, i.e., a maximum luminescence, a minimum luminescence and a distribution for each luminescence.

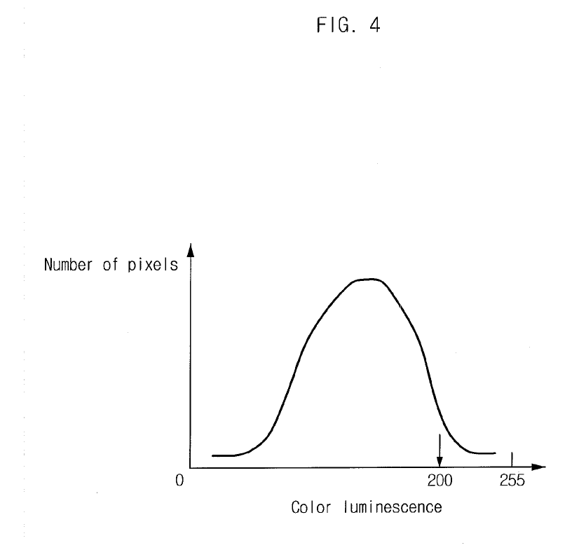

FIG. 4 is a graph illustrating a distribution of pixels for each luminescence in one frame, analyzed by a histogram analyzer, in which an example of a histogram made from one image is illustrated. Here, the abscissa of the histogram indicates R, G and B pixel values (or luminescence values), which has values between 0 and 255, and the ordinate of the histogram indicates a frequency generated for each pixel value.

The histogram analyzer 302 searches the number of pixels for each luminescence. If the number of pixels in an upper band (a portion of which luminescence is brighter than those of other portions) in FIG. 4 is within a predetermined range, e.g., 5% (allowable value), the histogram analyzer 302 inputs an output to the maximum luminescence determining and mapping unit 303 such that the luminescence “b” (See FIG. 2b) is determined to be the maximum luminescence of a display luminescence.

In other words, the maximum luminescence may vary depending on the histogram of pixels. For example, the maximum luminescence is determined depending on whether or not the distribution of pixels within the maximum luminescence of 5% is positioned above a predetermined luminescence. Since the abandonable limit 5% determines image quality, it may be seen as an allowable value with regard to degradation of image quality.

In this case, the histogram analysis result for the corresponding frame indicates that the number of pixels corresponding to grays 201 to 255 is within 5% of the total number of pixels. Thus, when the maximum luminescence is determined to be “b”, the maximum luminescence to be displayed becomes the luminescence “b”, and the original grays at 0 to 200 steps are mapped correspondingly.

The maximum luminescence determining and mapping unit 303 determines the maximum luminescence as described above and then performs mapping. In this case, a data is inputted from the main memory 304. The data is an image data in an n-th frame and is the same frame as the image data inputted to the histogram analyzer 302.

Referring back to FIG. 3a, if an image data to be displayed for each frame is inputted to the buffer memory 301, the histogram analyzer 302 analyzes the image data for each frame to calculate the parameters, i.e., a mean luminescence, a maximum/minimum luminescence, a histogram for each of the R, G and B colors. The calculated results are outputted to the maximum luminescence determining and mapping unit 303 for each frame.

Meanwhile, the image data stored in the buffer memory 301 is sent to the main memory 304, and the image data outputted from the main memory 304 is inputted to the DAC 305. The aforementioned output from the histogram analyzer 302 is inputted to the maximum luminescence determining and mapping unit 303.

The maximum luminescence determining and mapping unit 303 determines the maximum luminescence based on the output from the histogram analyzer 302, and maps grays less bright than the maximum luminescence.

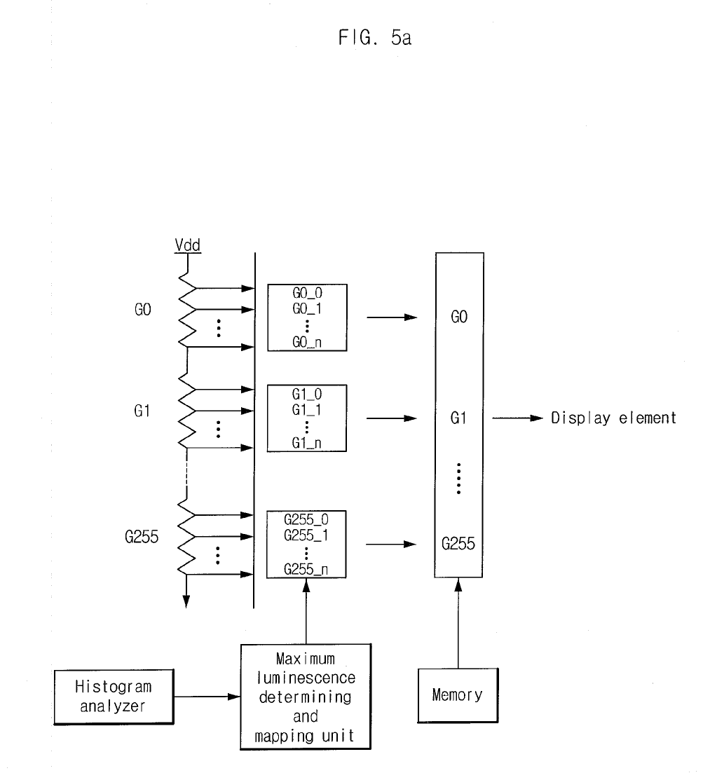

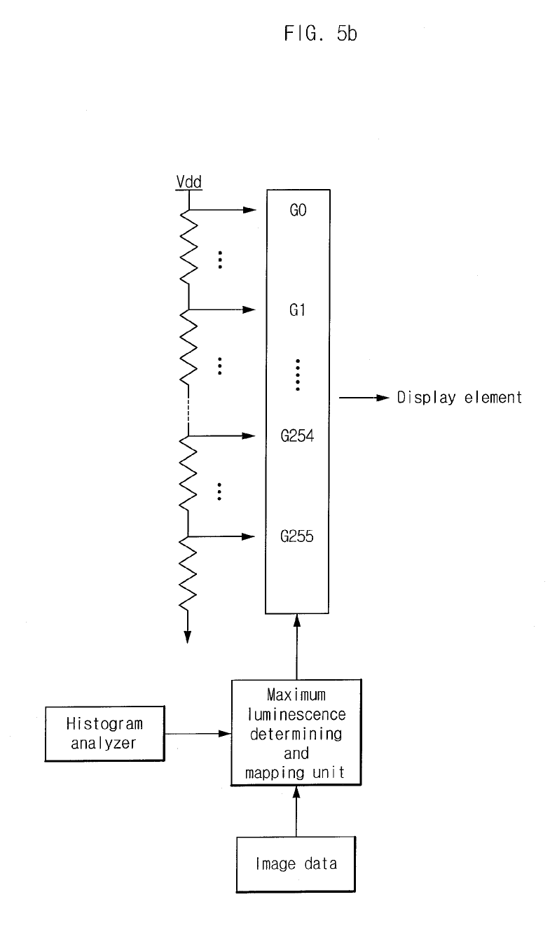

The configuration of the DAC 305 is shown in FIG. 5a. A mapping process is described with reference to FIG. 5a. The mapping process is performed through two steps. Each original gray is divided into n+1 resolutions, and a primary mapping process is performed with one of the n+1 resolutions based on the maximum luminescence determined by the maximum luminescence determining and mapping unit 303, on the basis of the result of the histogram analyzer 302. For example, in the primary mapping process, G0 is divided into n+1 resolutions, i.e., G0_0 to G0_n, and the primary mapping process is performed with one gray of G0_0 to G0_n.

Thereafter, a secondary mapping process is performed with grays of an actual image data inputted from the main memory 304 for each of the R, G and B colors. For example, if a gray of the color R in the image data is G0, the gray is mapped to a gray G50 when the secondary mapping process is performed. The gray G50 is mapped to the gray G0_15 primarily mapped to be suitable for the maximum luminescence changed in the primary mapping process, and then finally sent to a display element 306.

As such, the gray G50 finally mapped in the primary and secondary mapping processes is mapped to the gray G0_15, which is optimized to be suitable for the changed maximum luminescence, and then sent to a multiplexer to be outputted in place of the gray G0 of the original image data.

If G0 has to be mapped to G50.5 under a histogram condition, through the primary and secondary mapping processes, the original image gray G0 is not mapped to the gray G50 or G51, a digital value, but the image gray G0 is primarily mapped to one appropriate analog value of G0_0 to G0_n to be suitable for the changed maximum luminescence and then the value is transferred, thereby improving image quality than G0 being mapped to the G50 or G51 directly.

A second embodiment of the present invention is illustrated in FIG. 3b. This embodiment is different from the first embodiment in that an image data is not sent from the buffer memory 301 to the histogram analyzer 302, but an image data in the buffer memory 301 is sent to the main memory 304 to store a certain amount of data and then sent to the histogram analyzer 302 and the DAC 305. However, subsequent operations are the same as those of the first embodiment.

A third embodiment of the present invention is illustrated in FIG. 3c. As described above, the mapping process is divided into primary and secondary steps in the first embodiment of the present invention. But the mapping process is performed once in the third embodiment of the present invention. That is, if an image data is inputted from the buffer memory 301 to the histogram analyzer 302, the histogram analyzer 302 analyzes the image data, the maximum luminescence is determined in accordance with the analyzed image data, and the image data is mapped in accordance with the determined maximum luminescence. Thus, if a gray of R color in the original image data is a gray G150, the determined maximum luminescence is simply mapped to a gray G200 and sent to the display element 306.

A fourth embodiment of the present invention is illustrated in FIG. 3d. The fourth embodiment of the present invention is different from the third embodiment in that an image data is not directly inputted from the buffer memory 301 to the histogram analyzer 302, but an image data in the buffer memory 301 is inputted to the main memory 304 and then inputted from the main memory 304 to the histogram analyzer 302. However, since subsequent operations are the same as those of the third embodiment, detailed descriptions will be omitted.

Unlike the conventional DBC in which analysis and display of an image data are performed sequentially, the analysis of an image data in a corresponding frame and the display of the image data in the frame are performed simultaneously. Consequently, the maximum luminescence determining and mapping unit 303 for selecting a backlight luminescence in accordance with an image data for each frame is used to improve the quality of display.

The subsequent operations are the same as those of a general display driving circuit. The DAC 305 sends an electrical signal to be displayed to the display element 306 using a mapping data for each gray corresponding to the maximum backlight voltage determined by the maximum luminescence determining and mapping unit 303 and an image data inputted from the main memory 304.

FIGS. 5a and 5b illustrate the DAC 305 for converting an image data mapped for the luminescence outputted from the maximum luminescence determining and mapping unit 303 into an electrical signal according to an embodiment of the present invention.

As illustrated in FIG. 5a, the DAC 305 performs an operation of primarily mapping an original gray to one of G0_0 to G0_n in accordance with the maximum luminescence determined by the maximum luminescence determining and mapping unit 303 and then receiving an original digital image signal inputted from the main memory 304 to secondarily map one (e.g., the gray G10_10) of the original grays to the gray G50. In this case, the electrical signal may be a voltage or current, and may vary depending on the display element. If values of maximum and minimum voltages are inputted, the luminescence of an image data in a corresponding frame is displayed within the values of the maximum and minimum voltages.

As illustrated in FIG. 5b, the DAC 305 maps a gray of an image data from the main memory 304 in accordance with a signal determined by the maximum luminescence determining and mapping unit 303 based on the analysis result of the histogram analyzer 302, and then converts the image data into an analog signal to be outputted to a display element.

As described above, the backlight luminescence is adjusted for each frame in accordance with a maximum luminescence, a minimum luminescence, a histogram for each color, thereby reducing power consumption. In addition, colors in a frame are analyzed and the corresponding frame is simultaneously displayed based on the analyzed result, thereby improving quality of still and moving images and reducing unnecessary power consumption.

And it is possible to embody specified light to current frame data by analyzing an input data in real time and it is possible to be more natural and soft image quality by mapping to more correct gray.

While the present invention has been particularly shown and described with reference to exemplary embodiments thereof, it will be understood by those of ordinary skill in the art that various changes in form and details may be made therein without departing from the spirit and scope of the present invention as defined by the following claims. Therefore, the scope of the present invention should be understood within the scope of the present invention defined by the appended claims.

What is claimed is:

1. A device for driving a display element, comprising:
a buffer memory for receiving a frame image data and temporarily storing the frame image data;
a main memory for receiving the frame image data inputted from the buffer memory and storing the inputted frame image data;
a histogram analyzer for receiving the frame image data to analyze a color distribution for each frame;
a maximum luminescence determining and mapping unit for receiving an output inputted from the histogram analyzer to map a luminescence in accordance with an adjusted maximum luminescence; and
a digital-to-analog converter (DAC) for receiving an output inputted from the maximum luminescence determining and mapping unit to convert the output into an electrical signal and then output the electrical signal.

2. The device according to claim 1, wherein the histogram analyzer receives the frame image data inputted from the buffer memory or the main memory.

3. The device according to claim 1, wherein the maximum luminescence determining and mapping unit receives the frame image data inputted from the histogram analyzer and the main memory.

4. The device according to claim 1, wherein the DAC receives an output of the main memory together with an output of the maximum luminescence determining and mapping unit to convert the output into an electrical signal and then output the electrical signal.

5. The device according to claim 1, wherein the output of the histogram analyzer is a parameter calculated by analyzing a mean luminescence, a maximum/minimum luminescence, and/or a histogram for each color of a pixel.

6. The device according to claim 1, wherein the pixel constituting the frame image data includes red (R), green (G) and blue (B) components.

7. The device according to claim 1, wherein a histogram is indicated by a frequency of pixel values of the R, G and B components in the pixel constituting the frame image data.

8. The device according to claim 1, wherein the electrical signal is a voltage or a current.

9. The device according to claim 3, wherein the frame image data inputted from the main memory to the maximum luminescence determining and mapping unit is an image data in the same frame as the image data inputted to the histogram analyzer.

10. A method for driving a display element, comprising:
receiving a frame image data and storing the frame image data in a buffer memory;
inputting the frame image data stored in the buffer memory to a main memory;
inputting the frame image data to a histogram analyzer to analyze a color distribution for each frame and then output the analyzed color distribution;
inputting the output from the histogram analyzer to a maximum luminescence determining and mapping unit to map a luminescence in accordance with an adjusted maximum luminescence and then output the mapped luminescence; and
inputting the output of the maximum luminescence determining and mapping unit to a DAC to convert the output into an electrical signal and then output the electrical signal to a display element.

11. The method according to claim 10, wherein the histogram analyzer receives the frame image data inputted from the buffer memory or the main memory.

12. The method according to claim 10, wherein the maximum luminescence determining and mapping unit receives the frame image data inputted from the histogram analyzer and the main memory to map a luminescence in accordance with an adjusted maximum luminescence and then output the mapped luminescence.

13. The method according to claim 10, wherein the DAC receives an output of the main memory together with an output of the maximum luminescence determining and mapping unit to convert the output into an electrical signal and then output the electrical signal.

14. The method according to claim 10, wherein the output from the histogram analyzer is a parameter calculated by analyzing a mean luminescence, a maximum/minimum luminescence, and/or a histogram for each color of a pixel.

15. The method according to claim 10, wherein the pixel constituting the frame image data includes red (R), green (G) and blue (B) components.

16. The method according to claim 10, wherein a histogram is indicated by a frequency of pixel values of the R, G and B components in the pixel constituting the frame image data.

17. The method according to claim 10, wherein the electrical signal is a voltage or a current.

18. The method according to claim 12, wherein the frame image data inputted from the main memory to the maximum luminescence determining and mapping unit is an image data in the same frame as the image data inputted to the histogram analyzer.
